(19) United States
(12) Patent Application Publication
(10) Pub. No.: US 2025/0051877 A1
(43) Pub. Date: Feb. 13, 2025

(54) CURING PROCESS FOR SURFACE DEFECTS OF CATHODE MATERIAL

(71) Applicant: Ascend Elements, Inc., Westborough, MA (US)

(72) Inventors: Yadong Liu, Westborough, MA (US); Eric Gratz, Westborough, MA (US); Haixia Deng, Westborough, MA (US); Dhiren Mistry, Westborough, MA (US); Anil Parmar, Westborough, MA (US); Martha Monzon, Westborough, MA (US)

(21) Appl. No.: 18/231,953

(22) Filed: Aug. 9, 2023

(51) Int. Cl. C22B 3/00; C22B 3/08; C22B 26/12; C22B 47/00; H01M 10/54

(52) U.S. Cl. CPC C22B 23/043; C22B 3/08; C22B 26/12; C22B 47/00; H01M 10/54

(57) ABSTRACT

A curing process for cathode material alleviates surface defects on particles of the cathode material for improving battery performance. Heat treating a granular form of the cathode material in a flow of an oxygen-containing gas removes surface defects on the cathode material particles that have been mechanically deagglomerated. This results in significant improvement in both the rate of charge/discharge and the number of recharge cycles.

### BACKGROUND

Battery recycling has gained significant attention with the increased focus on electrical energy as an alternative to so-called fossil fuels that store energy in a combustible hydrocarbon form. Batteries, or more specifically secondary or rechargeable batteries, include a charge material adapted to store energy in the form of electrons that can be invoked to generate a current flow when connected to an electrical load, such as an electric vehicle (EV). Reversal of the electron flow causes the electrons to flow back into the battery in a cyclic charging and discharging iteration. The charge material is based on a specific atomic structure for providing a beneficial energy capacity, discharge rate, and number of charge cycles tolerable by the battery. Charge material includes cathode material and anode material, representing respective electrodes and corresponding polarity of the battery. The cathode material stores the electrical energy in the form of electrons and forms an electrical flow to the anode material (usually carbon and/or graphite) during battery usage and discharge. Accordingly, a specific composition of the charge material, including a particular ratio and purity of charge material metals, is significant for assuring predictable high performance from the battery.

### SUMMARY

A curing process is described for cathode materials that alleviates surface defects on deagglomerated particles of the cathode material, resulting in improved battery performance. Heat treating a granular form of the cathode material, formed by sintering a cathode material precursor and lithium salts followed by mechanical deagglomeration, has been found to remove surface defects on the cathode material particles, and surprising improving both the rate of charge/discharge and the number of recharge cycles in the final battery. More particularly, a recycling stream of waste batteries provides cathode material metals including nickel, manganese and cobalt from which the cathode material precursor is formed. Specifically, in a recycling process, Ni, Mn and Co are leached into a leach solution in a ratio dependent upon the battery chemistry of the recycling stream, and this ratio is subsequently adjusted for a particular target ratio of Ni, Mn and Co (NMC). A coprecipitation process generates a granular form of the NMC as a precursor to the charge material. Sintering of the precursor with Li salts forms an active cathode material for a Li-ion battery, which, after mechanical deagglomeration, then undergoes a curing process for surface defect mitigation and correction.

Configurations herein are based, in part, on the observation that battery charge materials, and particularly cathode materials, demand a specific ratio, purity and morphology for maintaining prescribed performance according to a manufacturing specification, typically set by the battery or automotive vendor. Unfortunately, conventional approaches to cathode material generation suffer from the shortcomings that the use of recycled charge material metals in formation of new, recycled batteries can introduce surface defects into the cathode material. Accordingly, configurations herein substantially overcome the shortcomings of conventional recycling by providing a curing process including heat treatment for the charge material particles, which was found to significantly reduce the presence of the surface defects and improve the electrochemical performance of the cathode material in the new, recycled battery.

In further detail, a particular process is disclosed herein that includes a method of producing a cathode material from a recycled lithium-ion battery stream by leaching a black mass from the recycled lithium-ion battery stream to obtain a leach solution, including a molar ratio of metallic elements, and adjusting the ratio of the metallic elements in the leach solution to a selected molar ratio with additional metal salts. In an example arrangement, Ni, Mn and Co are the charge material metals, leached from the black mass with sulfuric acid (H₂SO₄) and ratio-adjusted with sulfate salts of the NMC. The metallic elements and the additional metal salts undergo coprecipitation from the leach solution to form a cathode material precursor (pCAM) having the selected ratio. This pCAM is then sintered with a lithium salt to form a sintered cathode material (CAM) that is subsequently mechanically deagglomerated to form an intermediate cathode material, which may be prone to surface defects. The curing process herein includes heat treating the intermediate cathode material to form the cured, improved cathode material having fewer surface defects.

### BRIEF DESCRIPTION OF THE DRAWINGS

The foregoing and other features will be apparent from the following description of particular embodiments disclosed herein, as illustrated in the accompanying drawings in which like reference characters refer to the same parts throughout the different views. The drawings are not necessarily to scale, emphasis instead being placed upon illustrating the principles of the invention.

FIG. 1 is a context diagram of defect curing of a granular mass of charge materials such as cathode material in configurations herein;

FIG. 2 is a recycling process using defect removal curing in configurations herein;

FIG. 3 is a graph of rate performance in the cured cathode material of FIG. 1; and

FIG. 4 is a graph of rate performance in the cured cathode material of FIG. 1.

### DETAILED DESCRIPTION

An example of a curing method for surface defect mitigation in cathode materials appears below. Curing includes heating in an oven or similar heat generating appliance for a prescribed time, at a prescribed temperature or range, and under prescribed conditions. The examples below depict curing in conjunction with an NMC battery recycling process, however any suitable cathode material may be employed.

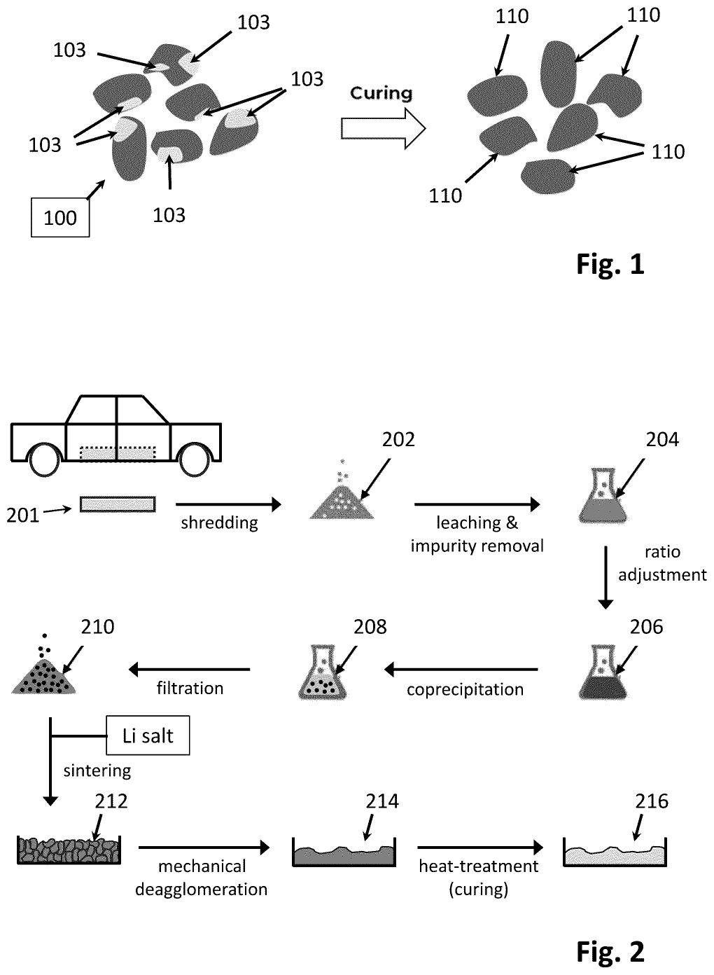

FIG. 1 is a context diagram of defect curing of a granular mass of charge material such as cathode material in configurations herein. Forming a recycled battery, such as a Li-ion battery, includes granular masses of cathode material and anode material, such as graphite. The granular mass of cathode material is typically combined with conductive and binder materials and adhered to a planar sheet of conductive material (usually copper or aluminum) to form the battery electrodes. FIG. 1 depicts the granular mass 100 of active cathode material, meaning cathode material precursor (NMC) previously sintered with Li salts. As shown, individual particles of the sintered cathode material exhibit surface defects 103, including surface roughness and cracking. Conventional approaches use this material despite these defects. In contrast, configurations herein perform a heat-treating step to substantially eliminate the defects 103 and to form defect-free or defect-reduced particles 110 of active cathode material for the recycled battery.

An example recycling scenario suitable for use with configurations herein begins with a deployed lithium-ion battery, typically from an electric vehicle (EV). Li-ion batteries have a finite number of charge cycles before the ability of the charge material to accept sufficient charge degrades substantially. Add to this the batteries from premature end-of-life due to vehicle failure, collision damage, etc. The collective end-of-life recycling stream contributes to an abundant supply of exhausted batteries comprising spent cells and charge material. Such batteries contain cathode material metals, including Ni, Mn, Co, anode materials of carbon and graphite, and current collectors including Al and Cu. The batteries are discharged and then agitated into a granular black mass through physical grinding, shredding and pulverizing. The black mass, including the cathode material, anode material, and any incidental casing and current collectors such as copper and aluminum, is used to form a leach solution of dissolved charge material metals.

In this example, the leach solution includes at least Ni, Mn and Co, typically as sulfate salts from sulfuric acid leaching. However, other charge material metals and/or leach acid may be employed. The leach solution has a molar ratio of charge material metals (such as Ni, Mn and Co) based on the constituent composition of the incoming recycling stream. The molar ratio can then be adjusted with additional metal salts (Ni, Mn and Co salts), such as sulfate salts (typically a virgin or control form of fresh materials) to yield a target ratio-adjusted solution for the new, recycled battery.

A coprecipitation reaction occurs by adjusting (increasing) the pH of the leach solution for precipitating the charge material metals (charge materials) in the desired ratio resulting from the adjustment. Sodium hydroxide or another strong base causes the charge material metals, such as NMC, to fall out of solution in a granular form, separable by filtration, typically as hydroxides. In addition, a chelating agent, such as ammonium hydroxide, may also be used to form the coprecipitated product. This granular material coprecipitated from the pH adjustment of the leach solution forms the cathode material precursor, having the desired molar ratio for a target battery chemistry for the new, recycled batteries. Sintering in a furnace with lithium carbonate or other lithium salts forms the active cathode material for the recycled Li-ion battery.

In a specific example configuration, active cathode material LiNiₓMn_{y}Co_{z}O₂ is synthesized by sintering NiₓMn_{y}Co_{z}(OH)₂ and Li₂CO₃, where x, y and z represent the respective molar ratios of Ni, Mn and Co. Common chemistries include NMC 111, representing equal molar components of Ni, Mn and Co, NMC 811, NMC 622 and NMC 532, however any suitable molar ratio may be achieved by the ratio adjustment in the leach solution followed by sintering.

FIG. 2 is a process flow of recycling using the defect removal curing of the present disclosure. Referring to FIGS. 1 and 2, the method of producing a cathode material from a recycled lithium-ion battery stream includes leaching a black mass 202 obtained from the recycled lithium-ion battery stream, typically from EV batteries 201 by grinding and shredding, to obtain a leach solution 204 including a molar ratio of metallic elements such as nickel, manganese, and cobalt, although other cathode material metals may also be dissolved depending on the source of the recycled battery stream. Following impurity removal, such as by filtration to remove insoluble components such as anode materials (graphite), the leach solution is a substantially pure composition of the metallic elements. The ratio of these metallic elements is then adjusted in the leach solution to a selected molar ratio with additional metal salts, forming a leach solution having the desired molar ratio of the metallic elements 206. In an example process, the black mass is leached with an aqueous acid such as sulfuric acid, and ratio adjustment occurs by addition of sulfate salts of the metallic elements nickel, manganese, and cobalt. Hydrogen peroxide or other oxidizing/reducing agents may also be added to the leach solution.

The pH of the adjusted leach solution is increased to coprecipitate the metallic elements and the additional metal salts from the leach solution to form the cathode material precursor having the selected ratio 210 in particulate form. It may be preferable to employ a preferred ratio of high nickel, such as NMC-622 or NMC-811, such that the cathode material precursor contains greater than 60 mole % nickel. The coprecipitated cathode material precursor 210 may preferably have a single crystal structure, contributing to higher performance in the final battery.

A combination of the cathode material precursor 210 and a lithium salt, such as lithium carbonate, is sintered to form a sintered cathode material 212. Preferably, at this stage, the sintered cathode material has achieved a single crystal structure. Configurations herein mechanically deagglomerate the sintered cathode material to form an intermediate cathode material having a reduced particle size that is more convenient for forming cathodes for recycled batteries. Types of deagglomeration include physical agitation via grinding, mortar and pestle, jet-milling, or other physical dissociation of the granular cathode material particles.

However, through this process, defects result in the surface of the intermediate cathode material, as shown in FIG. 1. Conventional approaches use this as active cathode material in spite of their surface defects for combination with conductive particles and a binder in formation of a recycled battery. However, in contrast to these conventional approaches, in the present configurations, a curing step is used to significantly remove or eliminate the surface defects from the intermediate cathode material.

This curing stage involves heat treatment of the intermediate cathode material under controlled heating conditions. At this stage, the sintered cathode material may already have achieved a single crystal structure, although manifesting noticeable surface defects that can have a negative effect on quality. The heat treatment of the intermediate cathode material may occur in a furnace that is heated to a temperature of from 500° to 900° C. and augmented by a flow of an oxygen-containing gas. The heat treatment is performed at a lower temperature than the sintering that formed the material, thereby providing a type of curing process aimed solely at surface defects. The flow of oxygen-containing gas may simply be fan-driven atmospheric air and propelled at a flow rate of from 0.2 to 16 standard cubic feet per minute (SCFM). In results described further below, the cathode material following curing by heat treatment has been found to have 80% fewer surface defects than the intermediate cathode material. In some cases, complete or nearly complete elimination of these surface defects has been found.

The cured cathode material can then be employed as active cathode material in a recycled battery. It has been surprisingly found that the cathode material cured as described and having reduced surface defects has improved overall properties, including specific capacity and capacity retention, compared to the sintered cathode material.

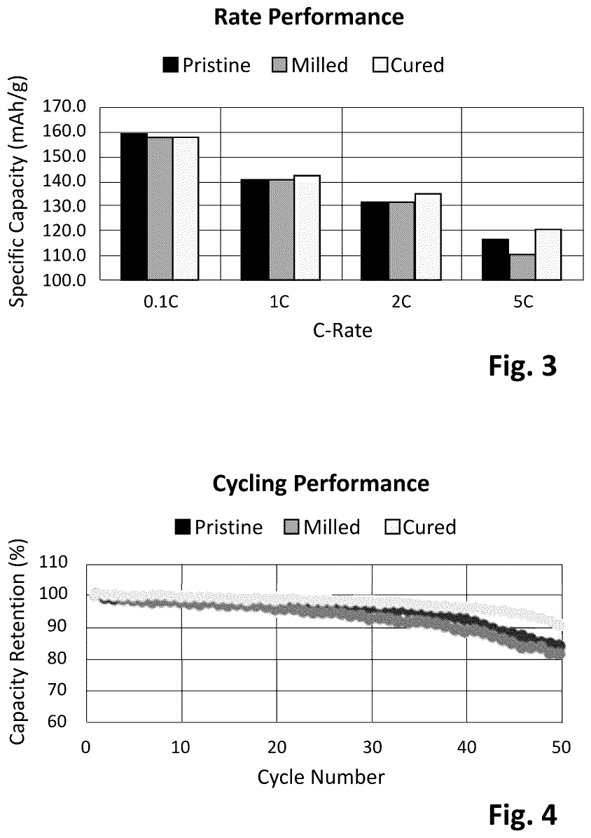

FIG. 3 is a graph of rate performance in the cured cathode material of FIG. 1. In particular, referring to FIG. 3, specific capacity on the vertical axis is plotted against discharge rates on the horizontal axis. Test samples of pristine material (sintered cathode material prepared by sintering cathode material precursor and lithium salts), milled material (mechanically deagglomerated sintered cathode material to form intermediate cathode material), and cured material that has undergone heat treatment under an oxygen-containing gas flow) are shown. As can be seen, the cured material showed significant improvements in specific capacity, particularly at the higher discharge rates.

FIG. 4 is another graph of rate performance in the cured cathode material of FIG. 1. In particular, as shown in FIG. 4, capacity retention on a vertical axis is plotted against a number of cycles on a horizontal axis. Again, test samples of pristine material, milled material, and cured material are shown. As is expected, charge materials generally lose some retention over a number of charge cycles. However, the results in FIG. 4 show that the cured material provides a significant improvement in capacity retention over both the milled and pristine materials, maintaining a high capacity over 40-50 charge cycles.

While the system and methods defined herein have been particularly shown and described with references to embodiments thereof, it will be understood by those skilled in the art that various changes in form and details may be made therein without departing from the scope of the invention encompassed by the appended claims.

What is claimed is:

1. A method of producing a cathode material from a recycled lithium-ion battery stream, comprising
leaching a black mass from the recycled lithium-ion battery stream to obtain a leach solution including a molar ratio of metallic elements,
adjusting the ratio of the metallic elements in the leach solution to a selected molar ratio with additional metal salts,
co-precipitating the metallic elements and the additional metal salts from the leach solution to form a cathode material precursor having the selected ratio,
sintering a combination of the cathode material precursor and a lithium salt to form a sintered cathode material,
mechanically deagglomerating the sintered cathode material to form an intermediate cathode material having surface defects, and
heat treating the intermediate cathode material to form the cathode material.

2. The method of claim 1, wherein the black mass is leached with an aqueous acid.

3. The method of claim 1, wherein the aqueous acid comprises sulfuric acid.

4. The method of claim 3, wherein the aqueous acid further comprises hydrogen peroxide.

5. The method of claim 1, wherein the metallic elements comprise at least one of nickel, manganese, and cobalt.

6. The method of claim 5, wherein the metallic elements are nickel, manganese, and cobalt.

7. The method of claim 1, wherein the cathode material precursor comprises greater than 60 mole % nickel.

8. The method of claim 1 wherein the cathode material precursor has a single crystal structure.

9. The method of claim 1, wherein the lithium salt is lithium carbonate.

10. The method of claim 1, wherein the sintered cathode material has a single crystal structure.

11. The method of claim 1, wherein the sintered cathode material is deagglomerated by milling.

12. The method of claim 11, wherein the sintered cathode material is deagglomerated by jet-milling.

13. The method of claim 1, wherein the intermediate cathode material is heat treated in a furnace having an oxygen-containing atmosphere flow.

14. The method of claim 13, wherein the oxygen-containing atmosphere is air.

15. The method of claim 13, wherein the flow is from 0.2 to 16 standard cubic feet per minute.

16. The method of claim 13, wherein the furnace is heated to a temperature of from 500° to 900° C.

17. The method of claim 1, wherein the surface defects are surface roughness, surface cracks, or a combination thereof.

18. The method of claim 1, wherein the cathode material has 80% fewer surface defects than the intermediate cathode material.

19. The method of claim 1, wherein the cathode material has improved specific capacity and improved capacity retention compared to the intermediate cathode material.

20. A cathode material prepared from a recycled lithium-ion battery stream, comprising a sintered combination of a cathode material precursor and lithium salts, the cathode material precursor comprising a co-precipitated mixture of:
metallic elements in a molar ratio obtained by leaching a black mass from the recycled lithium-ion battery stream and
additional metal salts provided to adjust the molar ratio of the metallic elements to a selected molar ratio,
wherein the sintered combination has been mechanically deagglomerated to form an intermediate cathode material having surface defects and heat treated to form the cathode material, the cathode material having fewer surface defects than the intermediate cathode material.
